(19) United States
(12) Patent Application Publication
(10) Pub. No.: US 2026/0160577 A1
(43) Pub. Date: Jun. 11, 2026

(54) ROAD SURFACE GENERATION METHOD AND APPARATUS, COMPUTER DEVICE, AND STORAGE MEDIUM

(71) Applicant: Tencent Technology (Shenzhen) Company Limited, Shenzhen (CN)

(72) Inventor: Tongxing XIAO, Shenzhen (CN)

(73) Assignee: Tencent Technology (Shenzhen) Company Limited, Shenzhen (CN)

(21) Appl. No.: 19/182,373

(22) Filed: Apr. 17, 2025

Related U.S. Application Data
(63) Continuation of application No. PCT/CN2024/089240, filed on Apr. 23, 2024.

(30) Foreign Application Priority Data
Apr. 24, 2023 (CN) 202310454010.1

(51) Int. Cl. G01C 21/00

(52) U.S. Cl. CPC G01C 21/3859; G01C 21/3819

(57) ABSTRACT

The present disclosure discloses a road surface generation method including: obtaining a plurality of road links of an electronic map, and expanding the plurality of road links to obtain a plurality of road surfaces having widths; determining a first group of width adjustment ratios for adjusting the widths of the plurality of road surfaces when overlap of road surfaces exists among the plurality of road surfaces; adjusting a width adjustment ratio of at least one road surface among the plurality of road surfaces in the first group of width adjustment ratios, to obtain a second group of width adjustment ratios, an absolute value of a difference between width adjustment ratios of any two road surfaces among the plurality of road surfaces being not greater than a ratio threshold; and adjusting the widths of the plurality of road surfaces based on the second group of width adjustment ratios.

### RELATED APPLICATION

This application is a continuation of and claims the benefit of priority to PCT Application No. PCT/CN2024/089240, filed Apr. 23, 2024, and entitled ROAD SURFACE GENERATION METHOD AND APPARATUS, COMPUTER DEVICE, AND STORAGE MEDIUM, which claims priority to Chinese Patent Application No. 202310454010.1, entitled “ROAD SURFACE GENERATION METHOD AND APPARATUS, COMPUTER DEVICE, AND STORAGE MEDIUM” filed on Apr. 24, 2023. The above applications are incorporated herein by reference in their entireties.

### FIELD OF THE TECHNOLOGY

Embodiments of the present disclosure relate to the field of map technologies, and in particular, to a road surface generation method and apparatus, a computer device, and a storage medium.

### BACKGROUND OF THE DISCLOSURE

Electronic maps are classified into high-precision electronic maps and common electronic maps. In a common electronic map, roads are represented by road links having no widths, and in a high-precision electronic map, roads are represented by road surfaces having widths. For an area having only a common electronic map and having no high-precision electronic maps, road surfaces may be developed according to road bars in the common electronic map, and then rendered and displayed, so as to implement a high-precision electronic map.

In the related technology, to avoid an overlapped region between developed road surfaces, the widths of the road surfaces may be adjusted according to width adjustment ratios. However, in this case, a difference between the width adjustment ratios of different road surfaces may be relatively large, resulting in distortion of a rendering effect of the road surfaces.

### SUMMARY

Embodiments of the present disclosure provide a road surface generation method and apparatus, a computer device, and a storage medium. Technical solutions are as follows:

An aspect provides a road surface generation method, the method including:
obtaining a plurality of road links of an electronic map, and expanding the plurality of road links to obtain a plurality of road surfaces having widths;
determining a first group of width adjustment ratios for adjusting the widths of the plurality of road surfaces in a case that overlap of road surfaces exists among the plurality of road surfaces;
adjusting a width adjustment ratio of at least one road surface among the plurality of road surfaces in the first group of width adjustment ratios, to obtain a second group of width adjustment ratios of the plurality of road surfaces, for the second group of width adjustment ratios, an absolute value of a difference between width adjustment ratios of any two road surfaces among the plurality of road surfaces being not greater than a ratio threshold; and
adjusting the widths of the plurality of road surfaces based on the second group of width adjustment ratios.

Another aspect provides a road surface generation apparatus, the apparatus including:
a data obtaining module, configured to obtain a plurality of road links of an electronic map, and expand the plurality of road links to obtain a plurality of road surfaces having widths;
a ratio determining module, configured to determine a first group of width adjustment ratios for adjusting the widths of the plurality of road surfaces in a case that overlap of road surfaces exists among the plurality of road surfaces;
a ratio adjusting module, configured to adjust a width adjustment ratio of at least one road surface among the plurality of road surfaces in the first group of width adjustment ratios, to obtain a second group of width adjustment ratios of the plurality of road surfaces, for the second group of width adjustment ratios, an absolute value of a difference between width adjustment ratios of any two road surfaces among the plurality of road surfaces being not greater than a ratio threshold; and
a road surface rendering module, configured to adjust the widths of the plurality of road surfaces based on the second group of width adjustment ratios.

Another aspect provides a computer device, the computer device including a processor and a memory, the memory having at least one computer program stored therein, the at least one computer program being loaded and executed by the processor, to implement the operations performed in the road surface generation method in the above aspects.

Another aspect provides a computer-readable storage medium, the computer-readable storage medium having at least one computer program stored therein, the at least one computer program being loaded and executed by a processor, to implement the operations performed in the road surface generation method in the above aspects.

Another aspect provides a computer program product, including a computer program, the computer program being loaded and executed by a processor, to implement operations performed in the road surface generation method in the above aspects.

According to the solutions provided in the embodiments of the present disclosure, road links are expanded to obtain a plurality of road surfaces, then width adjustment ratios of the plurality of road surfaces are determined, and if an absolute value of a difference between width adjustment ratios of two road surfaces is greater than a ratio threshold, the width adjustment ratios of the two road surfaces are considered to be imbalanced. Based on this, a width adjustment ratio of at least one road surface among the plurality of road surfaces is adjusted, to enable an absolute value of a difference between width adjustment ratios of any two road surfaces not to be greater than the ratio threshold, then the width of the road surface is adjusted based on the adjusted width adjustment ratio, and an adjusted road surface is rendered. According to the method, road surfaces having widths can be rendered according to road links having no widths, flickering of an electronic map image is reduced, and in addition, the accuracy of the road surfaces of the electronic map is improved.

### BRIEF DESCRIPTION OF THE DRAWINGS

To describe the technical solutions of the embodiments of the present disclosure more clearly, the following briefly introduces the accompanying drawings for describing the embodiments. Apparently, the accompanying drawings in the following description are mere examples, and a person of ordinary skill in the art may still derive other drawings from these accompanying drawings without creative efforts.

FIG. 1 is an example schematic diagram of an implementation environment according to an embodiment of the present disclosure.

FIG. 2 is an example schematic diagram of an electronic map according to an embodiment of the present disclosure.

FIG. 3 is a schematic diagram of an expanded electronic map according to an embodiment of the present disclosure.

FIG. 4A is an example flowchart of a road surface generation method according to an embodiment of the present disclosure.

FIG. 4B is an example schematic diagram of the road surface generation method according to the embodiment of the present disclosure.

FIG. 5 is an example flowchart of a road surface generation method according to an embodiment of the present disclosure.

FIG. 6 is an example flowchart of a road surface generation method according to an embodiment of the present disclosure.

FIG. 7 is an example flowchart of determining an imbalanced road surface pair according to an embodiment of the present disclosure.

FIG. 8 is an example flowchart of determining an imbalanced road surface group according to an embodiment of the present disclosure.

FIG. 9 is an example flowchart of determining an imbalanced road surface set according to an embodiment of the present disclosure.

FIG. 10 is an example schematic diagram of an imbalanced road surface set according to an embodiment of the present disclosure.

FIG. 11 is an example flowchart of for adjusting a width adjustment ratio according to an embodiment of the present disclosure.

FIG. 12 is an example flowchart of determining an imbalanced road surface set according to an embodiment of the present disclosure.

FIG. 13 is an example flowchart of a road surface generation method according to an embodiment of the present disclosure.

FIG. 14 is an example schematic diagram of a structure of a road surface generation apparatus according to an embodiment of the present disclosure.

FIG. 15 is an example schematic diagram of a structure of another road surface generation apparatus according to an embodiment of the present disclosure.

FIG. 16 is an example schematic diagram of a structure of a terminal according to an embodiment of the present disclosure.

FIG. 17 is an example schematic diagram of a structure of a server according to an embodiment of the present disclosure.

### DESCRIPTION OF EMBODIMENTS

To make the objectives, technical solutions, and advantages of embodiments of the present disclosure clearer, the following further describes the implementations of the present disclosure in detail with reference to the accompanying drawings.

The terms “first”, “second”, and the like used in the present disclosure may be used for describing various concepts in this specification. However, the concepts are not limited by the terms unless otherwise specified. The terms are merely used for distinguishing one concept from another concept.

“At least one” means one or more. For example, at least one imbalanced road surface set may be imbalanced road surface sets whose quantity is any integer greater than or equal to one, such as one imbalanced road surface set, two imbalanced road surface sets, or three imbalanced road surface sets. “A plurality of” means two or more. For example, a plurality of imbalanced road surface sets may be imbalanced road surface sets whose quantity is any integer greater than or equal to two, such as two imbalanced road surface sets or three imbalanced road surface sets. “Each” refers to each one of at least one. For example, each imbalanced road surface set refers to each imbalanced road surface set among a plurality of imbalanced road surface sets. If the plurality of imbalanced road surface sets are set to three imbalanced road surface sets, each imbalanced road surface set refers to each imbalanced road surface set among the three imbalanced road surface sets.

In a specific implementation of the present disclosure, relevant data such as road information and map data including location information of roads are involved. When the foregoing embodiments of the present disclosure are applied to specific products or technologies, collection, use, and processing of the relevant data need to comply with relevant laws, regulations, and standards of relevant countries and regions.

FIG. 1 is a schematic diagram of an implementation environment according to an embodiment of the present disclosure. Referring to FIG. 1, the implementation environment includes: a server 101 and a terminal 102. The server 101 and the terminal 102 are directly or indirectly connected in a wired or wireless communication protocol. The server 101 expands a plurality of road links in an electronic map in a road network database, to obtain a plurality of road surfaces, and determines a width adjustment ratio of each road surface. Based on this, the server 101 may further adjust the width adjustment ratios of the road surfaces, to enable an absolute value of a difference between adjusted width adjustment ratios of every two road surfaces not to be greater than a ratio threshold. Further, the server 101 may adjust the widths of the road surfaces according to the adjusted width adjustment ratios, to obtain adjusted road surface data. The server 101 may perform data compiling on the adjusted road surface data, to convert the road surface data in form of text files into data in form of binary files, and provide the data in form of binary files to an upper-layer application party (for example, a navigation application, a positioning application, or a rendering application) for invoking. In some embodiments, an electronic map application is installed on the terminal 102, for implementing functions such as map presentation and navigation. The server 101 is configured to provide a service for the electronic map application of the terminal 102. After obtaining the adjusted road surface data, the server 101 may further provide the adjusted road surface data to the electronic map application of the terminal 102. The terminal 102 renders the adjusted road surface data, and displays an electronic map obtained through rendering in the electronic map application, to provide an electronic map service.

In a possible implementation, the server 101 may be an independent physical server, or may be a server cluster or a distributed system formed by a plurality of physical servers, or may be a cloud server that provides a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform. The terminal 102 may be a smartphone, a tablet computer, a laptop, a desktop computer, a smart speaker, a smart watch, an in-vehicle terminal, or the like.

The road surface generation method provided in the embodiments of the present disclosure may be applied to a scenario of converting a common electronic map into a high-precision electronic map.

A common electronic map has a relatively low precision, and roads in the common electronic map are represented by a road link having no widths. A high-precision electronic map has a relatively high precision, and roads in the high-precision electronic map are represented by road surfaces having widths. Currently, lane-level navigation mainly uses a high-precision electronic map. However, in some areas, only map data for a common electronic map is provided, and map data for a high-precision electronic map is not provided. To obtain an effect similar to that of a high-precision electronic map in a place without map data for a high-precision electronic map, road information in a common electronic map needs to be expanded first to determine road surfaces, and then rendering and displaying are performed, so as to achieve the effect of the high-precision map.

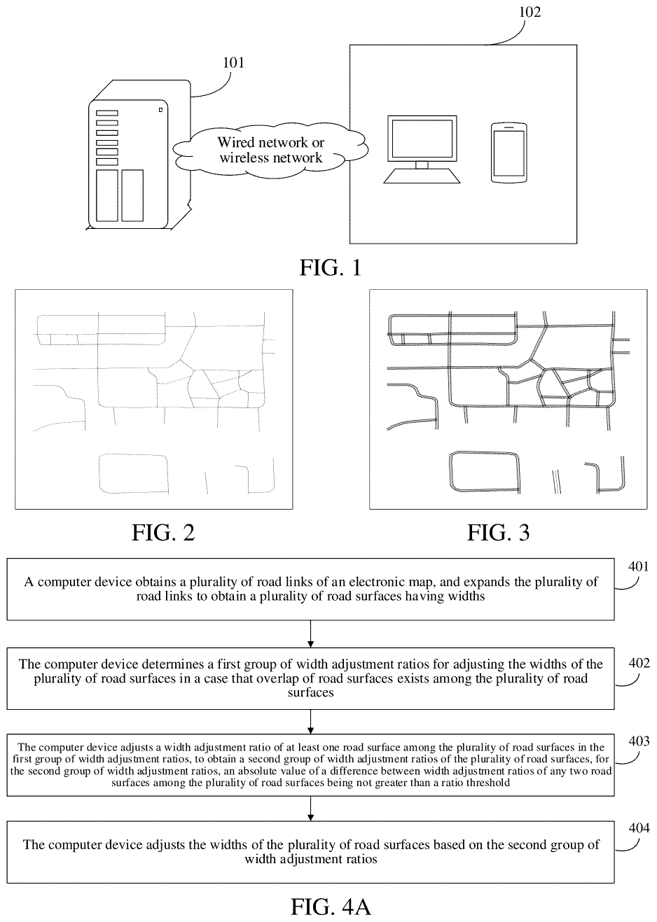

Each road link in the common electronic map has some road attribute information, for example, a road level and a lane quantity, and road widths can be determined according to the road attribute information. In the embodiments of the present disclosure, the road links may be considered as central lines of the road surfaces. FIG. 2 is a schematic diagram of an electronic map according to an embodiment of the present disclosure. As shown in FIG. 2, in a common electronic map, roads are represented by line segments having no widths. Each line segment represents a road, and each line segment is formed by several discrete shape dots. Road surfaces can be obtained by expanding road links shown in FIG. 2. FIG. 3 is a schematic diagram of an expanded electronic map according to an embodiment of the present disclosure. As shown in FIG. 3, borders are expanded toward two sides by using road links in an electronic map as central lines, to obtain road surfaces having widths.

The road surfaces are individually generated through expansion, and therefore, an overlap may occur between the road surfaces. An overlapped region exists between two road surfaces, and this may alternatively be referred to as that a covering relationship exists between two road surfaces, or an intersection region exists between two road surfaces. Z-fighting may occur in the overlapped region during rendering, which causes flickering of a presented image of the electronic map. To alleviate the flickering caused by overlapped regions between expanded road surfaces, widths of the road surfaces may be adjusted according to width adjustment ratios after expansion. However, in this way, a difference between width adjustment ratios of different road surfaces may be relatively large. As a result, a rendering effect of a road surface in the electronic map may be distorted to a relatively large extent compared with a corresponding road surface in reality, and therefore misleading to a user is brought about. By using the road surface generation method provided in this embodiment of the present disclosure, the width adjustment ratios of the road surfaces are adjusted. Therefore the problem of imbalance of the width adjustment ratios is alleviated, and the accuracy of subsequently obtained road surfaces in the electronic map is improved.

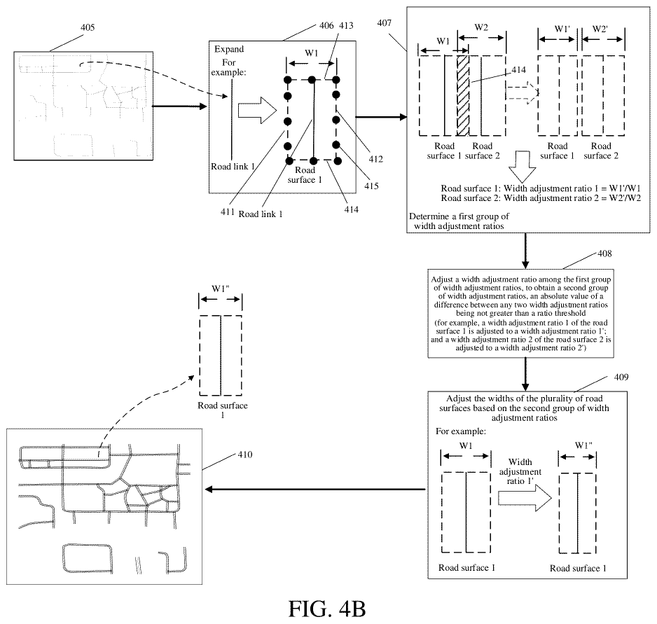

FIG. 4A is a flowchart of a road surface generation method according to an embodiment of this application. This embodiment of the present disclosure is performed by a computer device. Referring to FIG. 4A, the method includes the following operations.
401: A computer device obtains a plurality of road links of an electronic map, and expands the plurality of road links to obtain a plurality of road surfaces having widths.

In a common-precision electronic map, roads are represented by road links having no widths. In a high-precision electronic map, roads are represented by road surfaces having widths. To achieve an effect similar to a high-precision electronic map in an area without high-precision electronic map data, common-precision electronic map data is used to present an effect similar to a high-precision electronic map. Road links in the common-precision electronic map may be expanded, to obtain road surfaces having widths.

FIG. 4B is a schematic diagram of the road surface generation method according to the embodiment of the present disclosure. Referring to FIG. 4B, the computer device obtains a plurality of road links of an electronic map 405. At a block 406, the computer device may expand the plurality of road links according to road attribute information of the plurality of road links, to obtain a plurality of road surfaces having widths. An exemplary road link is a road link 1. For example, after determining an initial width, e.g.., W1, corresponding to a road of the road link 1 according to road attribute information of the road link 1, the computer device may expand the road link 1 to two sides of the road link 1 by using the road link 1 as a central line according to the initial width, to determine two side borders 411 and 412 and two end borders 413 and 414 of a road surface. Based on this, the computer device uses a region enclosed by the two side borders 411 and 412 and the two end borders 413 and 414 as a road surface 1, having the width W1, after the road link 1 is expanded. The road surface obtained by expanding the road link may be referred to as an initial road surface. Initial border information of the initial road surface may include coordinates of a plurality of location points on the borders of the road surface, for example, a plurality of location points 415 on the side borders 411 and 412 and the end borders 413 and 414 in FIG. 4B. In this way, the four borders of the road surface may be represented by four groups of dot strings.
402: The computer device determines a first group of width adjustment ratios for adjusting the widths of the plurality of road surfaces in a case that overlap of road surfaces exists among the plurality of road surfaces.

To prevent different road surfaces from overlapping each other due to expansion, after the plurality of road surfaces are obtained, a width adjustment ratio of each road surface among the plurality of road surfaces may further be determined, and the width adjustment ratios are configured for adjusting the widths of the road surfaces, so that no overlapped regions exist between any two road surfaces. For example, as shown in a block 407 in FIG. 4B, the road surface 1 obtained by expanding the road link 1 may overlap a road surface 2, and an overlapped region is 414. To avoid an overlap between the road surface 1 and the road surface 2, a width adjustment ratio 1 of the road surface 1 and a width adjustment ratio 2 of the road surface 2 are determined, so that no overlapped regions exist between the two road surfaces after the widths of the road surface 1 and the road surface 2 are adjusted according to the width adjustment ratio 1 and the width adjustment ratio 2. According to FIG. 4B, the width adjustment ratio 1 of the road surface 1 is W1′/W1, and the width adjustment ratio 2 of the road surface 2 is W2′/W2. In this embodiment of the present disclosure, if a difference between width adjustment ratios of different road surfaces is relatively large, a distortion on the road surfaces in a rendered electronic map may be caused. Therefore, before adjusting the widths of the road surfaces according to the width adjustment ratios, the computer device first obtains the width adjustment ratios of the road surfaces, determines whether a difference between the width adjustment ratios of the road surfaces is relatively large, and in a case that the difference is relatively large, performs a process of the following operation 403.
403: The computer device adjusts a width adjustment ratio of at least one road surface among the plurality of road surfaces in the first group of width adjustment ratios, to obtain a second group of width adjustment ratios of the plurality of road surfaces, for the second group of width adjustment ratios, an absolute value of a difference between width adjustment ratios of any two road surfaces among the plurality of road surfaces being not greater than a ratio threshold.

If the absolute value of the difference between the width adjustment ratios of the two road surfaces is greater than the ratio threshold, the difference between the width adjustment ratios of the two road surfaces is relatively large and the width adjustment ratios of the two road surfaces are imbalanced. In other words, the imbalance of the width adjustment ratios of the two road surfaces means that the absolute value of the difference between the width adjustment ratios of the two road surfaces is greater than the ratio threshold. The ratio threshold may be preset. To avoid distortion of a rendered road surface due to the imbalance of the width adjustment ratios between the road surfaces, the computer device adjusts a width adjustment ratio of at least one road surface among the plurality of road surfaces, so that for the second group of width adjustment ratios, of the plurality of road surfaces, obtained after adjustment, the absolute value of the difference between the width adjustment ratios of any two road surfaces among the plurality of road surfaces is not greater than the ratio threshold, and therefore the imbalance of the width adjustment ratios is reduced. As shown in a block 408 in FIG. 4B, the width adjustment ratio 1 of the road surface 1 may be adjusted to a width adjustment ratio 1′, and the width adjustment ratio 2 of the road surface 2 may be adjusted to a width adjustment ratio 2′.
404: The computer device adjusts the widths of the plurality of road surfaces based on the second group of width adjustment ratios. The computer device may further render the road surfaces of the electronic map according to border information of the road surfaces whose widths are adjusted (as shown in 410 of FIG. 4B).

After determining the adjusted width adjustment ratio of the road surface, the computer device multiplies the adjusted width adjustment ratio by the initial width (the width of the road surface obtained through expansion) of the road surface, to obtain an adjusted width. The computer device performs calculation based on the adjusted width, to obtain border information of the road surface. The border information includes locations of the two side borders and the two end borders of the road surface in the electronic map. For example, at a block 409 in FIG. 4B, the adjusted width adjustment ratio 1′ of the road surface 1 is multiplied by the initial width W1 of the road surface 1, to obtain an adjusted width W1″ of the road surface 1. After the width of the road surface is adjusted, locations of the two side borders of the road surface in the electronic map may change compared with locations before the width of the road surface is adjusted. Therefore, the locations, in the electronic map, of the two side borders of the road surface whose width is adjusted may be determined based on the location, in the electronic map, of the road link corresponding to the road surface and the adjusted width of the road surface. Because the width adjustment ratios of the road surfaces are adjusted and the difference between the width adjustment ratios of any two of the adjusted road surfaces after the adjustment is not large, a ratio distortion problem does not occur in a process of rendering the road surfaces, and the rendering accuracy is improved.

According to the method provided in this embodiment of the present disclosure, road links in an electronic map are expanded, to obtain a plurality of road surfaces, then width adjustment ratios of the plurality of road surfaces are determined, and if an absolute value of a difference between width adjustment ratios of two road surfaces is greater than a ratio threshold, the width adjustment ratios of the two road surfaces are imbalanced. Based on this, a width adjustment ratio of at least one road surface among the plurality of road surfaces is adjusted, to enable an absolute value of a difference between width adjustment ratios of any two road surfaces not to be greater than the ratio threshold, then the width of the road surface is adjusted based on the adjusted width adjustment ratio, and an adjusted road surface is rendered. According to the method, road surfaces having widths can be rendered according to road links having no widths, and the distortion problem of the road surfaces caused by the imbalance of the width adjustment ratios is solved, thereby helping ensure the accuracy of the road surfaces.

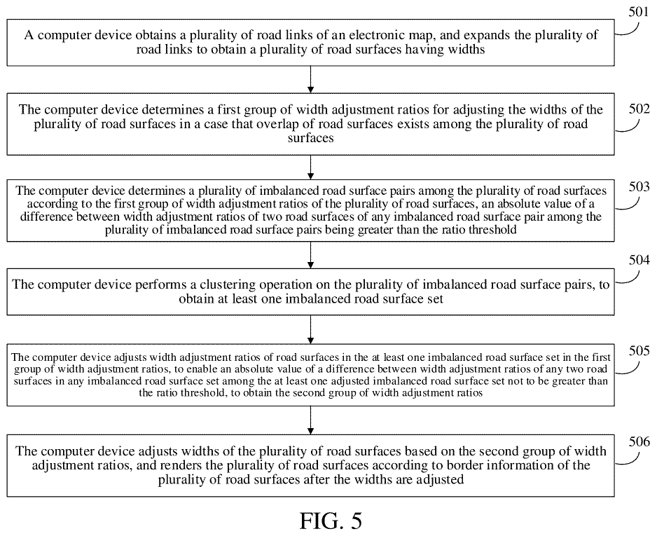

The embodiment shown in FIG. 4A and FIG. 4B is an example of the road surface generation method. For a detailed process of processing the road surfaces, the following embodiment shown in FIG. 5 may be referred to.

FIG. 5 is a flowchart of a road surface generation method according to an embodiment of the present disclosure. This embodiment of the present disclosure is performed by a computer device. Referring to FIG. 5, the method includes the following operations.
501: A computer device obtains a plurality of road links of an electronic map, and expands the plurality of road links to obtain a plurality of road surfaces having widths.

In a possible implementation, the process of expanding the road links, to obtain the road surfaces includes: obtaining road attribute information of the plurality of road links, determining initial widths of the plurality of road links according to the road attribute information, and expanding the plurality of road links according to the initial widths, to obtain the plurality of road surfaces.

The road attribute information includes a road type, a road level, a lane quantity, and the like. For example, the road type may be driveways, urban roads, a factory and mine roads, forestry roads, or the like. For example, the road level may be a fast road, a main road, a secondary road, a branch road, or the like. Still for example, the road level may further be an expressway, a first-level highway, a second-level highway, a third-level highway, a fourth-level highway, or the like.

The road engineering technical specification stipulates width ranges of lane widths in roads having different road attributes. Therefore, the initial widths of the road surfaces may be determined in combination with the ranges of the lane widths of road attribute that is stipulated by the road engineering technical specification. location information of the road links is defined in the electronic map. Therefore, after the initial widths of the road surfaces are determined, expansion to two sides is performed by using the road links as central lines according to the initial widths, to obtain the road surfaces.
502: The computer device determines a first group of width adjustment ratios for adjusting the widths of the plurality of road surfaces in a case that overlap of road surfaces exists among the plurality of road surfaces.

In a possible implementation, the computer device determines, among the plurality of road surfaces, a road surface pair having an overlapped region between the road surfaces; performs a clustering operation according to the plurality of overlapped road surface pairs, to obtain at least one overlapped road surface set; and determines width adjustment ratios of road surfaces in the overlapped road surface set, so that no overlapped regions exist between any two road surfaces obtained after widths of the road surfaces are adjusted based on the width adjustment ratios.

The computer device obtains initial border information of the expanded road surfaces, determines, according to the initial border information of the road surfaces, an overlapped road surface pair having an overlapped region between the road surfaces, and then determines width adjustment ratios of road surfaces in the overlapped road surface set.

The width adjustment ratio is a value ranging from 0 to 1. If the width adjustment ratio is 1, the widths of the road surfaces do not need to be adjusted. In some embodiments, the ratio threshold may be flexibly set according to an actual situation. For example, the ratio threshold is set to 0.05.
503: The computer device determines a plurality of imbalanced road surface pairs among the plurality of road surfaces according to the first group of width adjustment ratios of the plurality of road surfaces, an absolute value of a difference between width adjustment ratios of two road surfaces of any imbalanced road surface pair among the plurality of imbalanced road surface pairs being greater than the ratio threshold.

If the absolute value of the difference between the width adjustment ratios of the two road surfaces is greater than the ratio threshold, the difference between the width adjustment ratios of the two road surfaces is relatively large, the width adjustment ratios of the two road surfaces are imbalanced, and the two road surfaces are determined as an imbalanced road surface pair. In other words, the imbalance of the width adjustment ratios of the two road surfaces means that the absolute value of the difference between the width adjustment ratios of the two road surfaces is greater than the ratio threshold.
504: The computer device performs a clustering operation on the plurality of imbalanced road surface pairs, to obtain at least one imbalanced road surface set.

One imbalanced road surface set includes at least two road surfaces, and width adjustment ratios of any road surface in the imbalanced road surface set and at least one road surface in the imbalanced road surface set are imbalanced. That is, an absolute value of a difference between the width adjustment ratio of any road surface in the imbalanced road surface set and the width adjustment ratio of the at least one road surface in the imbalanced road surface set is greater than the ratio threshold.
505: The computer device adjusts width adjustment ratios of road surfaces in the at least one imbalanced road surface set in the first group of width adjustment ratios, to enable an absolute value of a difference between width adjustment ratios of any two road surfaces in any imbalanced road surface set among the at least one adjusted imbalanced road surface set not to be greater than the ratio threshold, to obtain the second group of width adjustment ratios.

One imbalanced road surface set or a plurality of imbalanced road surface sets may be provided. In a case that a plurality of imbalanced road surface sets are provided, because a same road surface is located in only one imbalanced road surface set, no coupling relationships exist between different imbalanced road surface sets. Therefore, the width adjustment ratios of the road surfaces are separately adjusted by using an imbalanced road surface set as a unit. On one hand, the problem of imbalanced width adjustment ratios is resolved. On the other hand, different imbalanced road surface sets are decoupled by means of clustering, and after a width adjustment ratio is adjusted for one road surface in one imbalanced road surface set, adjustment for another road surface in another imbalanced road surface set is not affected, and therefore, the error probability is reduced.

In a possible implementation, to improve the processing efficiency and shorten the processing time, width adjustment ratios of road surfaces in a plurality of imbalanced road surface sets may be adjusted concurrently. In some embodiments, the computer device invokes a plurality of threads to concurrently adjust the width adjustment ratios of the road surfaces in the plurality of imbalanced road surface sets. In some embodiments, a plurality of devices in a big data framework is invoked to adjust in parallel the width adjustment ratios of the road surfaces in the plurality of imbalanced road surface sets.
506: The computer device adjusts widths of the plurality of road surfaces based on the second group of width adjustment ratios, and renders the plurality of road surfaces according to border information of the plurality of road surfaces after the widths are adjusted.

The foregoing operations 503, 504, and 505 in FIG. 5 may be included in operation 403 in FIG. 4A, operation 506 may be a specific limitation to operation 404 in FIG. 4A, and operations 501 and 502 may correspond to operations 401 and 402 in FIG. 4A. Specific descriptions of the embodiments of FIG. 5, FIG. 4A, and FIG. 4B may be mutually referenced.

According to the method provided in this embodiment of the present disclosure, if the absolute value of the difference between the width adjustment ratios of two road surfaces is greater than the ratio threshold, the width adjustment ratios of the two road surfaces are imbalanced. Based on this, a plurality of imbalanced road surface pairs may be determined from the plurality of road surfaces. In addition, in consideration of the problem of imbalance of width adjustment ratios may exist between one road surface and a plurality of road surfaces, at least one imbalanced road surface set is obtained by clustering according to a plurality of imbalanced road surface pairs, and then the width adjustment ratios of the road surfaces in the imbalanced road surface set are adjusted, to enable the absolute value of the difference between the width adjustment ratios of any two road surfaces not to be greater than the ratio threshold, thereby solving the problem of road surface distortion caused by imbalance of the width adjustment ratios, and facilitating the ensuring of the adjustment accuracy of road surfaces.

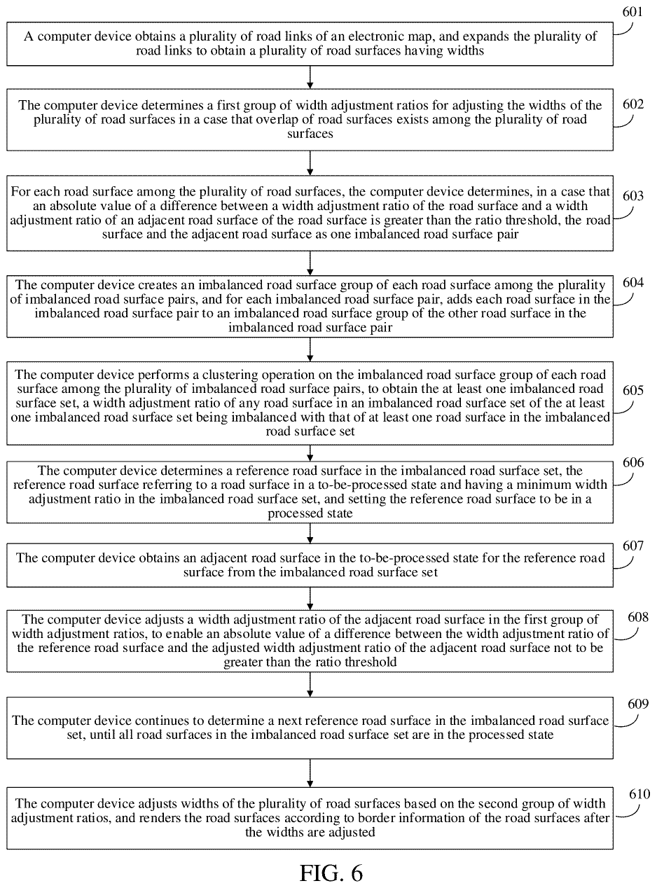

FIG. 6 is a flowchart of a road surface generation method according to an embodiment of the present disclosure. This embodiment of the present disclosure is performed by a computer device. Referring to FIG. 6, the method includes the following operations.
601: A computer device obtains a plurality of road links of an electronic map, and expands the plurality of road links to obtain a plurality of road surfaces having widths.
602: The computer device determines a first group of width adjustment ratios for adjusting the widths of the plurality of road surfaces in a case that overlap of road surfaces exists among the plurality of road surfaces.

Processes of operation 601 and operation 602 are similar to the processes of the foregoing operations 501 and 502 and the foregoing operations 401 and 402. Details are not described herein again.
603: For each road surface among the plurality of road surfaces, the computer device determines, in a case that an absolute value of a difference between a width adjustment ratio of the road surface and a width adjustment ratio of an adjacent road surface of the road surface is greater than the ratio threshold, the road surface and the adjacent road surface as one imbalanced road surface pair.

The absolute value of the difference between the width adjustment ratios of two road surfaces in any imbalanced road surface pair is greater than a ratio threshold.

In a possible implementation, the process of determining whether two road surfaces are adjacent includes the following operations. The computer device creates road space indexes based on a plurality of road links. The road space index includes a minimum bounding rectangle (MBR) of each road link of the plurality of road links. The computer device determines, in a case that an overlapped region exists between MBRs of two road links, that road surfaces corresponding to the two road links are adjacent road surfaces of each other.

In some embodiments, the road space indexes are an R tree. The R tree is a tree-like data structure or a hierarchical data structure configured for storing spatial data. The computer device adds the plurality of road links to the R tree. For any road link, other road links having overlapped regions with the MBR of the road link is searched for. These road links are adjacent road links of the road link, and road surfaces corresponding to these road links are adjacent road surfaces of the road surfaces corresponding to the road links.

In some embodiments, for example, for a road surface, the road surface is used as a key, adjacent roads of the road surface are used as values, and the values are stored in an internal memory in a storage form of mapping. Alternatively, the road surface and the adjacent road surfaces are stored in an external memory in a storage form of a database. The two storage forms both support efficient retrieval, or may be serialized into a json format or a binary format, to facilitate transmission in a network.

In this embodiment of the present disclosure, whether road surfaces are adjacent is determined by determining whether the MBRs of the road links are overlapped. Compared with a method of directly determining whether the road surfaces are adjacent by using a distance, the method is more efficient and accurate, thereby helping improving the processing efficiency.

In a possible implementation, to improve the processing efficiency and shorten the processing time, adjacent road surfaces of each road surface among the plurality of road surfaces may be concurrently calculated. The computer device may invoke a plurality of threads to concurrently calculate the adjacent road surfaces of each road surface of the plurality of road surfaces. A plurality of devices in a big data framework are invoked to concurrently calculate the adjacent road surfaces of each road surface of the plurality of road surfaces.

In a possible implementation, the process of determining an imbalanced road surface by the computer device includes the following operations. The computer device traverses the plurality of adjacent road surfaces of the road surface, uses each adjacent road surface among the plurality of adjacent road surfaces as a currently traversed adjacent road surface, and performs the following operations: comparing, in a case that a serial number of the road surface is less than a serial number of the currently traversed adjacent road surface, the width adjustment ratio of the road surface and a width adjustment ratio of the currently traversed adjacent road surface; and determining, by the computer device in a case that an absolute value of a difference between the width adjustment ratio of the road surface and the width adjustment ratio of the currently traversed adjacent road surface is greater than the ratio threshold, the road surface and the currently traversed adjacent road surface as one imbalanced road surface pair.

Each road surface has a serial number. Whether to process the currently traversed road surface is determined according to a value of the serial number, so that the problem that two road surface pairs are repeatedly generated for two identical road surfaces can be avoided. For example, the road surface 1 is adjacent to the road surface 2, and the absolute value of the difference between the width adjustment ratio of the road surface 1 and the width adjustment ratio of the road surface 2 is greater than the ratio threshold. If the serial numbers of the road surfaces are not determined, an imbalanced road surface pair including the road surface 1 and the road surface 2 and an imbalanced road surface pair including the road surface 2 and the road surface 1 are generated. As a result, two repeated road surfaces are generated. By comparing the serial numbers of two road surfaces, it can be ensured that only an imbalanced road surface pair including the road surface 1 and the road surface 2 is generated.

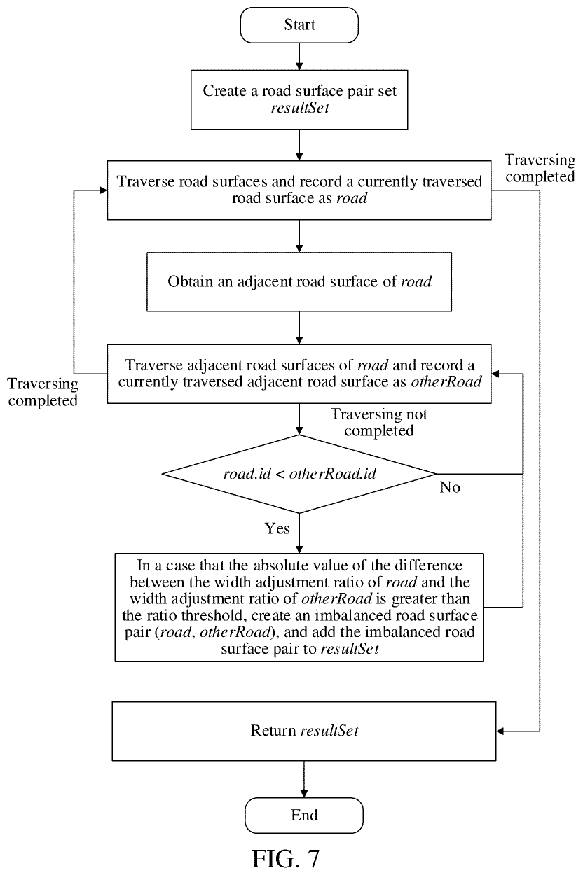

FIG. 7 is a flowchart of determining an imbalanced road surface pair according to an embodiment of the present disclosure. As shown in FIG. 7, the computer device first creates a road surface pair set resultSet. The road surface pair set resultSet is configured for storing an imbalanced road surface pair and is initially empty. The computer device traverses the road surfaces, to perform the following processing. The computer device records a currently traversed road surface as road, obtains an adjacent road surface of road, traverses the adjacent road surface of road, and records the currently traversed adjacent road surface as otherRoad. The computer device determines whether a serial number road.id of road is less than a serial number otherRoad.id of otherRoad. If road.id is not less than otherRoad.id, the computer device directly traverses a next otherRoad and performs subsequent processing. If road.id is less than otherRoad.id, in a case that the absolute value of the difference between the width adjustment ratio of road and the width adjustment ratio of otherRoad is greater than the ratio threshold, the computer device creates an imbalanced road surface pair (road, otherRoad), adds the imbalanced road surface pair to resultSet, then traverses a next otherRoad, and performs subsequent processing. After traversing of the plurality of road surfaces is completed, resultSet is returned to, so as to obtain a plurality of imbalanced road surface pairs.

In a possible implementation, to improve the processing efficiency and shorten the processing time, whether each road surface among the plurality of road surfaces and an adjacent road surface are of an imbalanced road surface pair may be concurrently calculated. For example, the computer device invokes the plurality of threads to concurrently calculate whether each road surface among the plurality of road surfaces and an adjacent road surface are of an imbalanced road surface pair. Alternatively, for example, the computer device invokes a plurality of devices in a big data framework to concurrently calculate whether each road surface among the plurality of road surfaces and an adjacent road surface are of an imbalanced road surface pair.

In this embodiment of the present disclosure, the foregoing operation 603 is performed, so as to determine an imbalanced road surface pair according to the width adjustment ratios of the plurality of road surfaces. In addition, in another embodiment, whether two road surfaces are adjacent may alternatively be not considered, and any two road surfaces whose width adjustment ratios having a difference with an absolute value greater than the ratio threshold is determined as an imbalanced road surface pair.

Operation 603 may be included in the foregoing operation 503.
604: The computer device creates an imbalanced road surface group of each road surface among the plurality of imbalanced road surface pairs, and for each imbalanced road surface pair, adds each road surface in the imbalanced road surface pair to an imbalanced road surface group of the other road surface in the imbalanced road surface pair.

The computer device creates an imbalanced road surface group for each road surface among the plurality of imbalanced road surface pairs. The imbalanced road surface group is configured for storing road surfaces having width adjustment ratios imbalanced with that of the road surface, that is, storing road surfaces whose width adjustment ratios have absolute values of differences with a width adjustment ratio of the road surface being greater than the ratio threshold. The computer device traverses the plurality of imbalanced road surface pairs and uses each imbalanced road surface pair among the plurality of imbalanced road surface pairs as a currently traversed imbalanced road surface pair. For the currently traversed imbalanced road surface pair, the computer device adds each road surface in the imbalanced road surface pair to an imbalanced road surface group of the other road surface.

For example, the imbalanced road surface pair includes a road surface A and a road surface B. The road surface A corresponds to an imbalanced road surface group Set1, and the road surface B corresponds to an imbalanced road surface group Set2. The computer device adds the road surface A to the imbalanced road surface group Set2 of the road surface B, and adds the road surface B to the imbalanced road surface group Set1 of the road surface A.

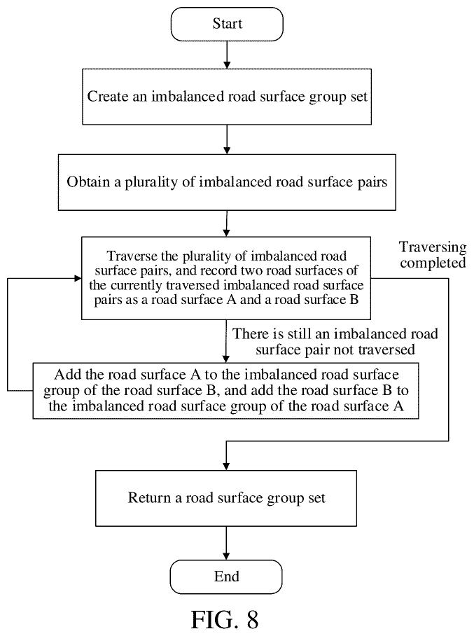

FIG. 8 is a flowchart of determining an imbalanced road surface group according to an embodiment of the present disclosure. As shown in FIG. 8, an imbalanced road surface group set is first created. The imbalanced road surface group set includes an imbalanced road surface group of each road surface and is initially empty.

A plurality of imbalanced road surface pairs are obtained. The plurality of imbalanced road surface pairs are traversed, and two road surfaces of the currently traversed imbalanced road surface pairs are recorded as a road surface A and a road surface B. The road surface A is added to an imbalanced road surface group of the road surface B, the road surface B is added to an imbalanced road surface group of the road surface A, a next imbalanced road surface pair is continuously traversed, and processing similar to that of the currently traversed imbalanced road surface pair is performed, until traversing of the plurality of road surface pairs is completed; then an imbalanced road surface group set is returned to, so as to obtain an imbalanced road surface group of each road surface.

In a possible implementation, to improve the processing efficiency and shorten the processing time, each road surface pair among the plurality of road surface pairs may be concurrently processed. For example, the computer device invokes a plurality of threads to concurrently process each road surface pair among the plurality of road surface pairs. Alternatively, for example, a plurality of devices in a big data framework are invoked to concurrently process each road surface pair among the plurality of road surface pairs.
605: The computer device performs a clustering operation on the imbalanced road surface group of each road surface among the plurality of imbalanced road surface pairs, to obtain the at least one imbalanced road surface set, a width adjustment ratio of any road surface in an imbalanced road surface set of the at least one imbalanced road surface set being imbalanced with that of at least one road surface in the imbalanced road surface set.

After obtaining the imbalanced road surface group of each road surface, the computer device performs a clustering operation according to the imbalanced road surface group of each road surface, to obtain an imbalanced road surface set. One imbalanced road surface set includes at least two road surfaces, and an absolute value of a difference between the width adjustment ratio of any road surface in the imbalanced road surface set and the width adjustment ratio of the at least one road surface in the imbalanced road surface set is greater than the ratio threshold.

In a possible implementation, the process of determining the imbalanced road surface set by the computer device includes the following operation 1 to operation 3.
Operation 1: The computer device creates a first set, the first set being configured for storing road surfaces having undergone clustering processing among the plurality of imbalanced road surface pairs, and the first set being initially empty.
Operation 2: The computer device traverses the road surfaces in the plurality of imbalanced road surface pairs, and in a case that the first set does not include a currently traversed road surface, creates an imbalanced road surface set; and operation 3 is performed. The imbalanced road surface set may be initially empty.

For the currently traversed road surface in the plurality of imbalanced road surface pairs, the computer device determines whether the road surface is in the first set. If the first set does not include the currently traversed road surface, the currently traversed road surface has not been processed yet, the computer device creates an imbalanced road surface set, the imbalanced road surface set is configured for storing a plurality of road surfaces obtained through clustering by using the currently traversed road surface as a clustering point. The first set is initially empty.

In addition, in operation 2, if the first set includes the currently traversed road surface, the currently traversed road surface has been processed, the currently traversed road surface does not need to be processed again, and a next road surface is directly used as the currently traversed road surface for subsequent processing.
Operation 3: The computer device adds the currently traversed road surface to the first set and the imbalanced road surface set, and adds the road surfaces in the imbalanced road group of the currently traversed road surface to the first set and the imbalanced road surface set; operation 2 is again performed, to continuously traverse a next road surface, and perform subsequent processing.

The computer device adds the currently traversed road surface to the first set, to indicate that the currently traversed road surface has been processed, so as to avoid subsequent repeated processing on the currently traversed road surface, and adds the currently traversed road surface to the imbalanced road surface set. Then, for each road surface (for example, the currently traversed road surface) in the imbalanced road surface set, by adding other road surfaces in the imbalanced road group of the road surface to the first set and the imbalanced road surface set, until any road surface in an imbalanced road group of any road surface in the imbalanced road surface set falls within the imbalanced road surface set, an imbalanced road surface set is successfully obtained through clustering. Then, the foregoing operation 2 is again performed, to use a next road surface as a currently traversed road surface for subsequent processing.

Therefore, after creating the first set, the computer device may traverse the road surfaces among the plurality of imbalanced road surface pairs, and perform the following operations: using each road surface among the plurality of imbalanced road surface pairs as a currently traversed road surface; creating an imbalanced road surface set in a case that the first set does not include the currently traversed road surface, adding the currently traversed road surface to the first set and the imbalanced road surface set, and adding the road surfaces in the imbalanced road group of the currently traversed road surface to the first set and the imbalanced road surface set.

In some embodiments, the adding the currently traversed road surface to the first set and the imbalanced road surface set, and adding the road surfaces in the imbalanced road group of the currently traversed road surface to the first set and the imbalanced road surface set may alternatively be implemented as follows. The computer device further creates a second set, the second set being configured for storing a road surface on which target processing is to be performed. The second set is initially empty. The computer device adds the currently traversed road surface to the first set and the second set, then performs the target processing on each road surface in the second set, and after the target processing is performed, continues to traverse a next road surface and performs subsequent processing, until the second set does not include any road surface. The performing the target processing on the road surface in the second set refers to: moving the road surface from the second set to the imbalanced road surface set, and for any imbalanced road surface in the imbalanced road surface group of the road surface, adding the imbalanced road surface to the first set and the second set in a case that the first set does not include the imbalanced road surface. Then, a new road surface is added to the second set, and the target processing is continuously performed on the new road surface, until all road surfaces in the second set are moved to the imbalanced road surface set and no new road surfaces are added to the second set. In this case, an imbalanced road surface set is successfully obtained through clustering, and then the foregoing operation 2 is continuously performed again, to traverse a next road surface and perform subsequent processing.

In this embodiment of the present disclosure, a road surface having an imbalanced width adjustment ratio is temporarily stored by using the second set. When the road surface is formally moved to the imbalanced road surface set, first, a road surface in an imbalanced road surface group of the road surface is added to the second set, and then the foregoing processing is cyclically performed, until all road surfaces in the second set are moved to the imbalanced road surface set, so that any two road surfaces that are imbalanced with each other can be successfully added to the imbalanced road surface set, and are not repeatedly processed, thereby ensuring the accuracy of the imbalanced road surface set obtained through clustering.

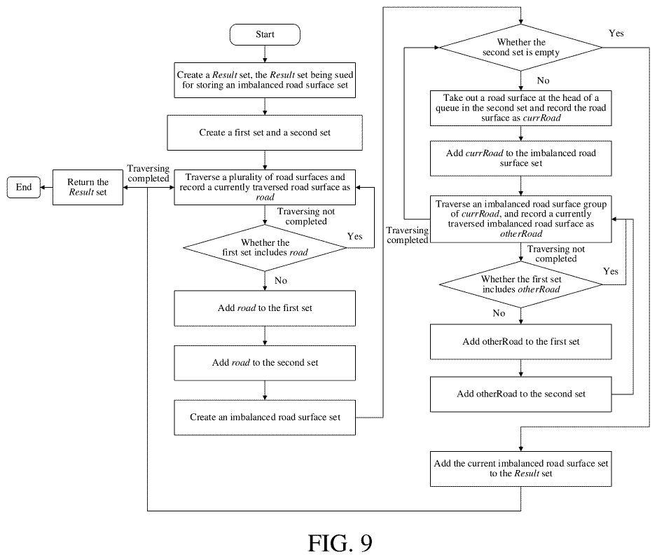

FIG. 9 is a flowchart of determining an imbalanced road surface set according to an embodiment of the present disclosure. As shown in FIG. 9, the method includes the following operations.
Operation 1: Create a Result set, the Result set being configured for storing an imbalanced road surface set and being initially empty; create a first set and a second set, the first set being configured for storing a processed road surface, and the second set being configured for storing a road surface on which target processing is to be performed, the first set and the second set being initially empty; a processed road surface being a traversed road surface or a road surface on which clustering processing has been performed.
Operation 2: Traverse a road surface among the plurality of imbalanced road surface pairs and record a currently traversed road surface as road; determine whether the first set includes road, and if the first set includes road, continuously traverse a next road surface and perform subsequent processing; if the first set does not include road, add road to the first set and add road to the second set, to create an imbalanced road surface set; and When traversing on the road surfaces in the plurality of imbalanced road surface pairs is completed, return to the Result set, to obtain the plurality of imbalanced road surface sets.
Operation 3: Determine whether the second set is empty, and if the second set is empty, add the current imbalanced road surface set to the Result set, and again perform operation 2, to continuously traverse a next road surface; if the second set is not empty, take out a road surface at the head of a queue in the second set and record the road surface as currRoad; and add currRoad to the imbalanced road surface set, traverse an imbalanced road surface group of currRoad, and recording a road surface in the currently traversed imbalanced road surface group as otherRoad.
Operation 4: Determine whether the first set includes otherRoad, and if the first set includes otherRoad, again perform operation 3, to continuously traverse a next imbalanced road surface in the imbalanced road surface group and perform a subsequent operation; if the first set does not include otherRoad, add the otherRoad to the first set, add otherRoad to the second set, then again perform operation 3, to continuously traverse a next imbalanced road surface in the imbalanced road surface group and perform a subsequent operation, until traversing of the imbalanced road surface group of currRoad is completed, again perform the foregoing operation 3, and perform a subsequent operation.

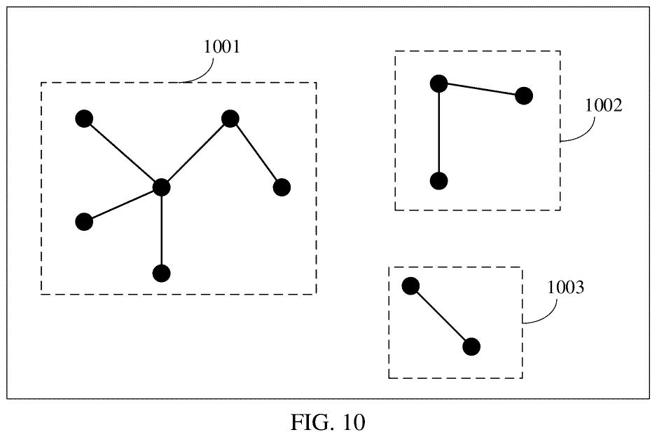

Because a width adjustment ratio imbalance relationship may exist between one road surface and a plurality of nearby road surfaces, the problem that road surfaces are clustered according to the width adjustment ratio imbalance relationship may be abstracted as a graph theory problem. FIG. 10 is a schematic diagram of an imbalanced road surface set according to an embodiment of the present disclosure. As shown in FIG. 10, each circular node in the figure represents a road surface, and two circular nodes connected by each line are an imbalanced road surface pair. A dashed-line box 1001, a dashed-line box 1002, and a dashed-line box 1003 respectively represent imbalanced road surface sets obtained through clustering, and each imbalanced road surface set includes at least two road surfaces. Therefore, the road surfaces are clustered according to the width adjustment ratio imbalance relationship, which may be performed by calculating communicated components of an undirected graph.

In this embodiment of the present disclosure, by performing the foregoing operations 604 and 605, a clustering operation on the plurality of imbalanced road surface pairs is implemented, to obtain at least one imbalanced road surface set. In addition, the computer device may alternatively obtain the imbalanced road surface set by means of clustering in another method. This is not limited in this embodiment of the present disclosure.
606: The computer device determines a reference road surface in the imbalanced road surface set, the reference road surface referring to a road surface in a to-be-processed state and having a minimum width adjustment ratio in the imbalanced road surface set, and sets the reference road surface to be in a processed state.

After the at least one imbalanced road surface set is obtained through clustering, the computer device adjusts a width adjustment ratio of a road surface in each imbalanced road surface set.

For example, one imbalanced road surface set is obtained. Initial states of road surfaces in the imbalanced road surface set are a to-be-processed state. The computer device determines, in the imbalanced road surface set, a road surface in the to-be-processed state and having a minimum width adjustment ratio, uses the road surface as a reference road surface, and subsequently no longer changes the width adjustment ratio of the reference road surface, but changes a width adjustment ratio of another road surface in the imbalanced road surface set by using the width adjustment ratio of the reference road surface as a reference. Therefore, the reference road surface may be set to be in the processed state.

In a possible implementation, the process of determining a reference road surface by the computer device includes the following operations. The computer device generates an index value of each road surface in the imbalanced road surface set, and creates a minimum index tree according to a width adjustment ratio of a road surface in the imbalanced road surface set, the minimum index tree including an index value of the road surface in the to-be-processed state, and a width adjustment ratio corresponding to an index value on a parent node in the minimum index tree being less than a width adjustment ratio corresponding to an index value on a child node. The computer device determines a road surface indicated by an index value on a root node of the minimum index tree as the reference road surface.

The root node refers to a node having no parent nodes in the minimum index tree. Each time a state or a width adjustment ratio of any road surface changes, the minimum index tree is updated, to ensure that the minimum index tree only includes an index value of the road surface in the to-be-processed state, and a width adjustment ratio corresponding to an index value on a parent node in the minimum index tree is less than a width adjustment ratio corresponding to an index value on a child node.

In this embodiment of the present disclosure, the data structure of the minimum index tree is used, so that the index value of the road surface having the minimum width adjustment ratio is always located at the root node of the minimum index tree, thereby improving the speed of searching for a road surface having a minimum width adjustment ratio and reducing the time complexity. In addition, the minimum index tree can support efficient modification of data in the tree. Therefore, the method of creating the minimum index tree is beneficial to improving the processing efficiency.

In some embodiments, if there are a relatively large quantity of road surfaces, searching for a road surface having a minimum width adjustment ratio among the road surfaces in a method of traversing the plurality of road surfaces has a relatively high time complexity. If there are a relatively large quantity of road surfaces, the method of using a minimum index tree has relatively few advantages. Therefore, the two methods may be combined. In a case that the quantity of road surfaces is greater than a quantity threshold, the method of using a minimum index tree is used to search for a road surface having a minimum width adjustment ratio among the road surfaces. In a case that the quantity of road surfaces is not greater than the quantity threshold, the method of traversing a plurality of road surfaces is used to search for a road surface having a minimum width adjustment ratio among the road surfaces.
607: The computer device obtains an adjacent road surface in the to-be-processed state for the reference road surface from the imbalanced road surface set.

The computer device determines the adjacent road surface of the reference road surface in the imbalanced road surface set and obtains a road surface in a to-be-processed state from the adjacent road surfaces of the reference road surface.
608: The computer device adjusts a width adjustment ratio of the adjacent road surface in the first group of width adjustment ratios, to enable an absolute value of a difference between the width adjustment ratio of the reference road surface and the adjusted width adjustment ratio of the adjacent road surface not to be greater than the ratio threshold.

After obtaining the adjacent road surface of the reference road surface, the computer device adjusts the width adjustment ratio of the adjacent road surface, to enable an absolute value of a difference between the width adjustment ratio of the reference road surface and the width adjustment ratio of the adjacent road surface not to be greater than the ratio threshold. Therefore, there is no longer the problem of imbalance of the width adjustment ratios between the adjacent road surface and the reference road surface.

In a possible implementation, the process of adjusting the width adjustment ratio of the adjacent road surface by the computer device includes: determining a sum of the width adjustment ratio of the reference road surface and the ratio threshold as a candidate width adjustment ratio, and determining a target width adjustment ratio as the adjusted width adjustment ratio of the adjacent road surface, the target width adjustment ratio being a minimum value of the width adjustment ratio of the adjacent road surface and the candidate width adjustment ratio. The adjusting the width adjustment ratio of the adjacent road surface may be represented by the following formula (1):

$$X 2 = min ( X 1 , Y + m ) \qquad ( 1 )$$

where X2 represents the width adjustment ratio of the adjacent road surface after the adjustment, X1 represents the width adjustment ratio of the adjacent road surface before the adjustment, Y represents the width adjustment ratio of the reference road surface, and m represents the ratio threshold.

In other words, in a case that the width adjustment ratio of the adjacent road surface is less than the candidate width adjustment ratio, equivalently, the width adjustment ratio of the adjacent road surface is not changed, and the width adjustment ratio of the adjacent road surface is kept unchanged.

The foregoing operation 608 is described by using an example in which a width adjustment ratio of one adjacent road surface is adjusted. Actually, the computer device performs the process of the foregoing operation 608 on each adjacent road surface obtained in the foregoing operation 607.
609: The computer device continues to determine a next reference road surface in the imbalanced road surface set, until all road surfaces in the imbalanced road surface set are in the processed state.

After completing the processing on each adjacent road surface obtained in the foregoing operation 607, the computer device continuously determines a next reference road surface in the imbalanced road surface set, and also performs the process of the foregoing operations 606 to 608 on the next reference road surface, until all of the road surfaces in the imbalanced road surface set are in the processed state.

In this embodiment of the present disclosure, the road surface having the minimum width adjustment ratio is used as a reference, to adjust another road surface having a width adjustment ratio imbalanced with that of the road surface. In this case, each road surface in the imbalanced road surface set is gradually adjusted. Whether a road surface needs to be adjusted is marked by using a processed state and an unprocessed state, and this is beneficial to avoiding an error.

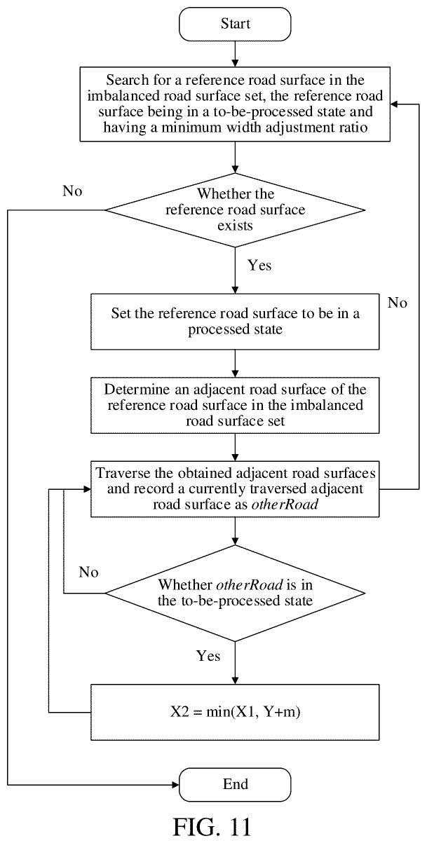

FIG. 11 is a flowchart of for adjusting a width adjustment ratio according to an embodiment of the present disclosure. As shown in FIG. 11, the method includes the following operations.
Operation 1: Search for a reference road surface in the imbalanced road surface set, the reference road surface being in a to-be-processed state and having a minimum width adjustment ratio in the imbalanced road surface set.
Operation 2: Determine whether the reference road surface exists, and if the reference road surface exists, set the reference road surface to be in a processed state. If the reference road surface does not exist, the procedure is ended.
Operation 3. Determine an adjacent road surface of the reference road surface in the imbalanced road surface set. The obtained adjacent road surfaces are traversed and a currently traversed adjacent road surface is recorded as otherRoad.
Operation 4: Determine whether otherRoad is in the to-be-processed state; if otherRoad is in the to-be-processed state, adjust a width adjustment ratio of otherRoad according to the foregoing formula (1), and then again perform the foregoing operation 3, to continuously use a next adjacent road surface as a currently traversed adjacent road surface; if otherRoad is not in the to-be-processed state, adjust the width adjustment ratio of otherRoad is not adjusted, and again perform the foregoing operation 3 directly, to continuously use a next adjacent road surface as a currently traversed adjacent road surface, until all of the adjacent road surfaces are traversed.

In this embodiment of the present disclosure, by performing the foregoing operations 606 to 609, the width adjustment ratio of the road surface in the imbalanced road surface set is adjusted, to enable an absolute value of a difference between width adjustment ratios of any two road surfaces in the adjusted imbalanced road surface set not to be greater than the ratio threshold. In addition, the computer device may further adjust the width adjustment ratios of the road surfaces in the imbalanced road surface set in another method.

In another embodiment, to ensure that the width adjustment ratios of the road surfaces are sufficiently adjusted, the foregoing operations 603 to 609 may be iteratively performed, until an iteration condition is satisfied. For example, the iteration condition is that a quantity of iterations reaches a target quantity of times, or the absolute value of the difference between the width adjustment ratios of any two road surfaces among the plurality of road surfaces is not greater than the ratio threshold.
610: The computer device adjusts widths of the plurality of road surfaces based on the second group of width adjustment ratios, and renders the road surfaces according to border information of the road surfaces after the widths are adjusted.

A process of operation 610 is similar to the process of the foregoing operation 403. Details are not described herein again.

According to the method provided in this embodiment of the present disclosure, if the absolute value of the difference between the width adjustment ratios of two road surfaces is greater than the ratio threshold, the width adjustment ratios of the two road surfaces are imbalanced. Based on this, a plurality of imbalanced road surface pairs may be determined among the plurality of road surfaces. In addition, in consideration of the problem of imbalance of width adjustment ratios may exist between one road surface and a plurality of road surfaces, at least one imbalanced road surface set is obtained by clustering according to a plurality of imbalanced road surface pairs, and then the width adjustment ratios of the road surfaces in the imbalanced road surface set are adjusted, to enable the absolute value of the difference between the width adjustment ratios of any two road surfaces not to be greater than the ratio threshold, thereby solving the problem of road surface distortion caused by imbalance of the width adjustment ratios, and facilitating the ensuring of the accuracy of road surfaces.

In addition, the method provided in this embodiment of the present disclosure has a strong robustness and is not limited by an initial shape of a road link. The width adjustment ratios are entirely and systematically adjusted on the road links within a given range, to reduce the ratio distortion. This method relies on a small amount of auxiliary information, does not need to introduce complex computing strategies to avoid extreme cases, has a good applicability, and can save computer resources.

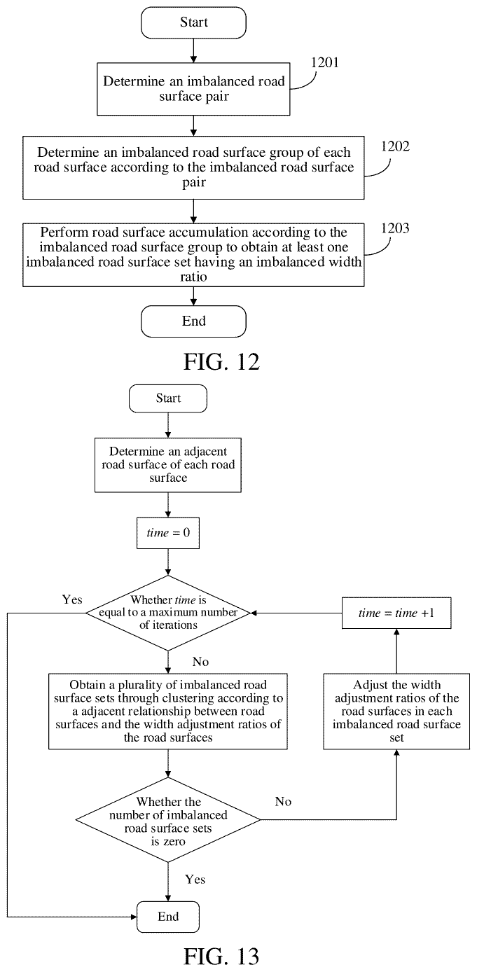

FIG. 12 is a flowchart of determining an imbalanced road surface set according to an embodiment of the present disclosure. As shown in FIG. 12, the method includes the following operations.
1201: Determine an imbalanced road surface pair.
1202: Determine an imbalanced road surface group of each road surface according to the imbalanced road surface pair.
1203: Perform road surface accumulation according to the imbalanced road surface group to obtain at least one imbalanced road surface set having an imbalanced width ratio.

FIG. 13 is a flowchart of a road surface generation method according to an embodiment of the present disclosure. As shown in FIG. 13, the method includes the following operations.
Operation 1: Determine an adjacent road surface of each road surface and set an initial value of a number of iteration times time to 0.
Operation 2. Determine whether time is equal to a maximum number of iterations; if time is equal to the maximum number of iterations, end the procedure; if time is not equal to the maximum number of iterations, obtain a plurality of imbalanced road surface sets through clustering according to an adjacent relationship between road surfaces and the width adjustment ratios of the road surfaces.
Operation 3: Determine whether the number of imbalanced road surface sets is zero; if the number of imbalanced road surface sets is zero, end the procedure; if the number of imbalanced road surface sets is not zero, adjust the width adjustment ratios of the road surfaces in each imbalanced road surface set, add 1 to a value of time, and again perform the foregoing operation 2.

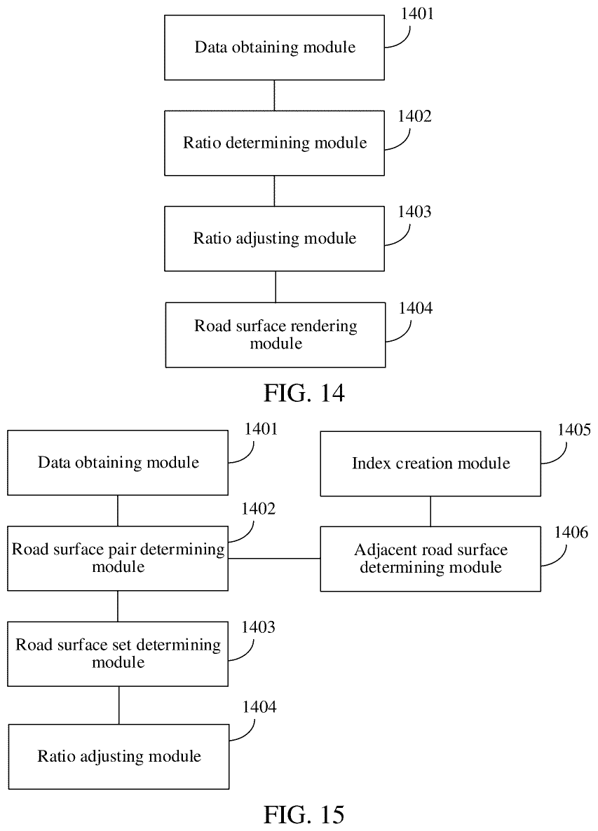

FIG. 14 is a schematic diagram of a structure of a road surface generation apparatus according to an embodiment of the present disclosure. Referring to FIG. 14, the apparatus includes:
a data obtaining module 1401, configured to obtain a plurality of road links of an electronic map, and expand the plurality of road links to obtain a plurality of road surfaces having widths;
a ratio determining module 1402, configured to determine a first group of width adjustment ratios for adjusting the widths of the plurality of road surfaces in a case that overlap of road surfaces exists among the plurality of road surfaces;
a ratio adjusting module 1403, configured to adjust a width adjustment ratio of at least one road surface among the plurality of road surfaces in the first group of width adjustment ratios, to obtain a second group of width adjustment ratios of the plurality of road surfaces, for the second group of width adjustment ratios, an absolute value of a difference between width adjustment ratios of any two road surfaces among the plurality of road surfaces being not greater than a ratio threshold; and
a road surface rendering module 1404, configured to adjust the widths of the plurality of road surfaces based on the second group of width adjustment ratios. The road rendering module 1404 is further configured to render the road surfaces according to the border information of the road surfaces whose widths are adjusted.

According to the road surface generation apparatus provided in this embodiments of the present disclosure, road links are expanded to obtain a plurality of road surfaces, then width adjustment ratios of the plurality of road surfaces are determined, and if an absolute value of a difference between width adjustment ratios of two road surfaces is greater than a ratio threshold, the width adjustment ratios of the two road surfaces are considered to be imbalanced. Based on this, a width adjustment ratio of at least one road surface among the plurality of road surfaces is adjusted, to enable an absolute value of a difference between width adjustment ratios of any two road surfaces not to be greater than the ratio threshold, then the width of the road surface is adjusted based on the adjusted width adjustment ratio, and an adjusted road surface is rendered. According to the method, road surfaces having widths can be rendered according to road links having no widths, and the distortion problem of the road surfaces caused by the imbalance of the width adjustment ratios is solved, thereby helping ensure the accuracy of the road surfaces.

In some embodiments, the ratio adjusting module 1403 is configured to:
determine a plurality of imbalanced road surface pairs among the plurality of road surfaces according to the first group of width adjustment ratios of the plurality of road surfaces, an absolute value of a difference between width adjustment ratios of two road surfaces of any imbalanced road surface pair among the plurality of imbalanced road surface pairs being greater than the ratio threshold;
perform a clustering operation on the plurality of imbalanced road surface pairs, to obtain at least one imbalanced road surface set; and
adjust width adjustment ratios of road surfaces in the at least one imbalanced road surface set in the first group of width adjustment ratios, to enable an absolute value of a difference between width adjustment ratios of any two road surfaces in any imbalanced road surface set among the at least one adjusted imbalanced road surface set not to be greater than the ratio threshold, to obtain the second group of width adjustment ratios.

In some embodiments, the ratio adjusting module 1403 is configured to:
for each road surface among the plurality of road surfaces, determine, in a case that an absolute value of a difference between a width adjustment ratio of the road surface and a width adjustment ratio of an adjacent road surface of the road surface is greater than the ratio threshold, the road surface and the adjacent road surface as one imbalanced road surface pair.

In some embodiments, the ratio adjusting module 1403 is configured to:
traverse a plurality of adjacent road surfaces of the road surface, and performing the following operations:
use each adjacent road surface among the plurality of adjacent road surfaces as a currently traversed adjacent road surface; compare, in a case that a serial number of the road surface is less than a serial number of the currently traversed adjacent road surface, the width adjustment ratio of the road surface and a width adjustment ratio of the currently traversed adjacent road surface; and
determine, in a case that an absolute value of a difference between the width adjustment ratio of the road surface and the width adjustment ratio of the currently traversed adjacent road surface is greater than the ratio threshold, the road surface and the currently traversed adjacent road surface as one imbalanced road surface pair.

In some embodiments, referring to FIG. 15, the apparatus further includes:
an index creation module 1405, configured to create road space indexes based on the plurality of road links, the road space indexes including a minimum bounding rectangle of each road link among the plurality of road links; and
an adjacent road surface determining module 1406, configured to determine, in a case that an overlapped region exists between MBRs of two road links, that road surfaces corresponding to the two road links are adjacent road surfaces of each other.

In some embodiments, the ratio adjusting module 1403 is configured to:
create an imbalanced road surface group for each road surface among the plurality of imbalanced road surface pairs, the imbalanced road surface group being configured for storing a road surface having a width adjustment ratio imbalanced with that of the road surface;
add, for each imbalanced road surface pair, each road surface in the imbalanced road surface pair to an imbalanced road surface group of the other road surface in the imbalanced road surface pair; and
perform a clustering operation on the imbalanced road surface group of each road surface among the plurality of imbalanced road surface pairs, to obtain the at least one imbalanced road surface set, a width adjustment ratio of any road surface in an imbalanced road surface set of the at least one imbalanced road surface set being imbalanced with that of at least one road surface in the imbalanced road surface set.

In some embodiments, the ratio adjusting module 1403 is configured to:
create a first set, the first set being configured for storing road surfaces having undergone clustering processing among the plurality of imbalanced road surface pairs;
traverse a road surface in the plurality of imbalanced road surface pairs, and perform the following operations:
using each road surface among the plurality of imbalanced road surface pairs as a currently traversed road surface; and
creating an imbalanced road surface set in a case that the first set does not include the currently traversed road surface, adding the currently traversed road surface to the first set and the imbalanced road surface set, and adding the road surfaces in the imbalanced road group of the currently traversed road surface to the first set and the imbalanced road surface set.

In some embodiments, the ratio adjusting module 1403 is configured to:
add the currently traversed road surface to the first set and a second set, the second set being configured for storing a road surface on which processing of creating an imbalanced road surface set is to be performed; and
perform target processing on each road surface in the second set, until the second set includes no road surfaces, and continue to traverse a next road surface,
performing target processing on the road surface referring to: moving the road surface from the second set to the imbalanced road surface set, and for any imbalanced road surface in the imbalanced road surface group of the road surface, adding the imbalanced road surface to the first set and the second set in a case that the first set does not include the imbalanced road surface.

In some embodiments, the ratio adjusting module 1403 is configured to:
determine a reference road surface in the imbalanced road surface set, the reference road surface referring to a road surface in a to-be-processed state and having a minimum width adjustment ratio in the imbalanced road surface set, and set the reference road surface to be in a processed state;
obtain an adjacent road surface in the to-be-processed state for the reference road surface from the imbalanced road surface set;
adjust a width adjustment ratio of the adjacent road surface in the first group of width adjustment ratios, to enable an absolute value of a difference between the width adjustment ratio of the reference road surface and the adjusted width adjustment ratio of the adjacent road surface not to be greater than the ratio threshold; and
continue to determine a next reference road surface in the imbalanced road surface set, until all road surfaces in the imbalanced road surface set are in the processed state.

In some embodiments, the ratio adjusting module 1403 is configured to:
determine a sum of the width adjustment ratio of the reference road surface and the ratio threshold as a candidate width adjustment ratio; and
determine a target width adjustment ratio as the adjusted width adjustment ratio of the adjacent road surface, the target width adjustment ratio being a minimum value of the width adjustment ratio of the adjacent road surface and the candidate width adjustment ratio.

In some embodiments, the ratio adjusting module 1403 is configured to:
generate an index value of each road surface in the imbalanced road surface set;
create a minimum index tree according to a width adjustment ratio of a road surface in the imbalanced road surface set, the minimum index tree including an index value of the road surface in the to-be-processed state, and a width adjustment ratio corresponding to an index value on a parent node in the minimum index tree being less than a width adjustment ratio corresponding to an index value on a child node; and
determine a road surface indicated by an index value on a root node of the minimum index tree as the reference road surface.

In some embodiments, the ratio determining module 1402 is configured to:
determine, among the plurality of road surfaces, a road surface pair having an overlapped region between the road surfaces;
perform a clustering operation according to the plurality of overlapped road surface pairs, to obtain at least one overlapped road surface set; and
determine width adjustment ratios of road surfaces in the overlapped road surface set, so that no overlapped regions exist between any two road surfaces obtained after widths of the road surfaces are adjusted based on the width adjustment ratios.

For the road surface generation apparatuses provided in the above embodiments, only division of the above functional modules is described by using examples. In practical application, the functions may be completed by different functional modules as required. To be specific, an internal structure of a computer device is divided into different functional modules to complete all or some of the functions described above. In addition, the road surface generation apparatus and road surface generation method embodiments provided in the foregoing embodiments belong to the same conception. For a specific implementation process, refer to the method embodiments, and details are not described herein again.

An embodiment of the present disclosure further provides a computer device, the computer device including a processor and a memory, at least one computer program being stored in the memory, and the at least one computer program being loaded and executed by the processor, to implement operations performed in the road surface generation method performed in the foregoing embodiments.

In some embodiments, the computer device is provided as a terminal. FIG. 16 is a schematic diagram of a structure of a terminal 1600 according to an exemplary embodiment of the present disclosure.

The terminal 1600 includes: a processor 1601 and a memory 1602.

The processor 1601 may include one or more processing cores, for example, a 4-core processor or an 8-core processor. The processor 1601 may be implemented in at least one hardware form of a digital signal processor (DSP), a field-programmable gate array (FPGA), and a programmable logic array (PLA). The processor 1601 may alternatively include a main processor and a coprocessor. The main processor is configured to process data in an active state, also referred to as a central processing unit (CPU). The coprocessor is a low-power processor configured to process the data in a standby state. In some embodiments, the processor 1601 may be integrated with a graphics processing unit (GPU). The GPU is configured to render and draw content that needs to be displayed on a display screen. In some embodiments, the processor 1601 may further include an artificial intelligence (AI) processor. The AI processor is configured to process computing operations related to machine learning.

The memory 1602 may include one or more computer-readable storage media. The computer-readable storage medium may be non-transient. The memory 1602 may further include a high-speed random access memory and a nonvolatile memory, for example, one or more disk storage devices or flash storage devices. In some embodiments, the non-transitory computer-readable storage medium in the memory 1602 is configured to store at least one computer program. The at least one computer program is used by the processor 1601 to implement the road surface generation method provided in the method embodiments of the present disclosure.

In some embodiments, the terminal 1600 may further include: a peripheral interface 1603 and at least one peripheral device. The processor 1601, the memory 1602, and the peripheral interface 1603 may be connected through a bus or a signal cable. Each peripheral may be connected to the peripheral interface 1603 through a bus, a signal cable, or a circuit board. In some embodiments, the peripheral device includes: at least one of a radio frequency circuit 1604, a display screen 1605, a camera assembly 1606, an audio circuit 1607, and a power supply 1608.

The peripheral interface 1603 may be configured to connect the at least one peripheral related to input/output (I/O) to the processor 1601 and the memory 1602. In some embodiments, the processor 1601, the memory 1602, and the peripheral interface 1603 are integrated on a same chip or circuit board. In some other embodiments, any or both of the processor 1601, the memory 1602, and the peripheral interface 1603 may be implemented on an independent chip or circuit board, which is not limited in this embodiment.

The RF circuit 1604 is configured to receive and transmit an RF signal, also referred to as an electromagnetic signal. The RF circuit 1604 communicates with a communication network and other communication devices through the electromagnetic signal. The RF circuit 1604 converts an electric signal into an electromagnetic signal for transmission, or converts a received electromagnetic signal into an electric signal. In some embodiments, the RF circuit 1604 includes: an antenna system, an RF transceiver, one or more amplifiers, a tuner, an oscillator, a DSP, a codec chipset, a user identity module card, and the like. The radio frequency circuit 1604 may communicate with another device through at least one wireless communication protocol. The wireless communications protocol includes, but is not limited to, a metropolitan area network, generations of mobile communication networks (2G, 3G, 4G, and 5G), a wireless local area network and/or a wireless fidelity (Wi-Fi) network. In some embodiments, the RF 1604 may further include a circuit related to NFC. This is not limited in the present disclosure.

The display screen 1605 is configured to display a user interface (UI). The UI may include a graph, text, an icon, a video, and any combination thereof. When the display screen 1605 is a touch display screen, the display screen 1605 further has a capability of acquiring a touch signal on or above a surface of the display screen 1605. The touch signal may be inputted to the processor 1601 as a control signal for processing. In this case, the display screen 1605 may be further configured to provide a virtual button and/or a virtual keyboard that are/is also referred to as a soft button and/or a soft keyboard. In some embodiments, one display 1605 may be arranged on a front panel of the terminal 1600. In some other embodiments, there may be at least two display screens 1605 respectively arranged on different surfaces of the terminal 1600 or in a folded design. In some other embodiments, the display 1605 may be a flexible display arranged on a curved surface or a folded surface of the terminal 1600. Even, the display screen 1605 may be further set in a non-rectangular irregular pattern, namely, a special-shaped screen. The display screen 1605 may be prepared by using materials such as a liquid crystal display (LCD), an organic light-emitting diode (OLED), or the like.

The camera assembly 1606 is configured to acquire images or videos. In some embodiments, the camera assembly 1606 includes a front-facing camera and a rear-facing camera. The front-facing camera is disposed on a front panel of the terminal 1600, and the rear-facing camera is disposed on a rear surface of the terminal 1600. In some embodiments, there are at least two rear cameras, which are respectively any of a main camera, a depth-of-field camera, a wide-angle camera, and a telephoto camera, to achieve background blur through fusion of the main camera and the depth-of-field camera, panoramic photographing and virtual reality (VR) photographing through fusion of the main camera and the wide-angle camera, or other fusion photographing functions. In some embodiments, the camera assembly 1606 may further include a flash. The flash may be a monochrome temperature flash, or may be a double color temperature flash. The double color temperature flash refers to a combination of a warm light flash and a cold light flash, and may be configured for light compensation under different color temperatures.

The audio circuit 1607 may include a microphone and a speaker. The microphone is configured to acquire sound waves of a user and an environment, and convert the sound waves into an electrical signal to input to the processor 1601 for processing, or input to the radio frequency circuit 1604 for implementing voice communication. For the purpose of stereo acquisition or noise reduction, there may be a plurality of microphones, respectively disposed at different portions of the terminal 1600. The microphone may further be an array microphone or an omni-directional acquisition type microphone. The speaker is configured to convert electric signals from the processor 1601 or the RF circuit 1604 into sound waves. The speaker may be a conventional film speaker, or may be a piezoelectric ceramic speaker. When the speaker is the piezoelectric ceramic speaker, the speaker not only can convert an electric signal into acoustic waves audible to a human being, but also can convert an electric signal into acoustic waves inaudible to a human being, for ranging and other purposes. In some embodiments, the audio circuit 1607 may further include an earphone jack.

The power supply 1608 is configured to supply power to assemblies in the terminal 1600. The power supply 1608 may be an alternating current, a direct current, a primary battery, or a rechargeable battery. When the power supply 1608 includes the rechargeable battery, the rechargeable battery may support wired charging or wireless charging. The rechargeable battery may be further configured to support a fast charging technology.

A person skilled in the art may understand that the structure shown in FIG. 16 constitutes no limitation on the terminal 1600, and the terminal may include more or fewer assemblies than those shown in the figure, or some assemblies may be combined, or a different assembly deployment may be used.

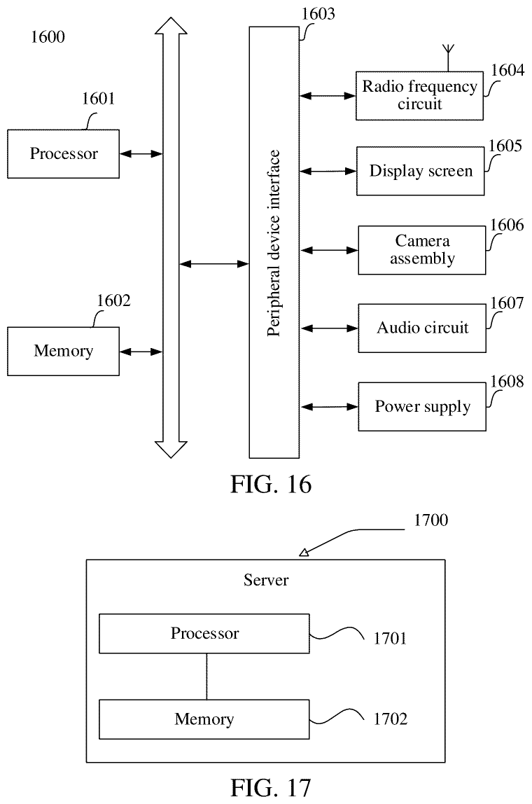

In some embodiments, the computer device is provided as a server. FIG. 17 is a schematic diagram of a structure of a server according to an embodiment of the present disclosure. The server 1700 may vary greatly due to different configurations or performance, and may include one or more central processing units (CPU) 1701 and one or more memories 1702. The memory 1702 has at least one computer program stored therein. The at least one computer program is loaded and executed by the processor 1701 to implement the methods provided in the foregoing method embodiments. It is clear that the server may further include components such as a wired or wireless network interface, a keyboard, and an input/output interface, to perform input and output. The server may further include another component configured to implement a device function. Details are not described herein again.

An embodiment of the present disclosure further provides a computer-readable storage medium, the computer-readable storage medium having at least one computer program stored therein, the at least one computer program being loaded and executed by a processor, to implement the operations of the road surface generation method provided in the foregoing embodiments.

An embodiment of the present disclosure further provides a computer program product, including a computer program. The computer program is loaded and executed by a processor, to implement operations performed in the road surface generation method provided in the foregoing embodiments. In some embodiments, computer programs involved in the embodiments of the present disclosure may be deployed on a computer device for execution, or may be executed on a plurality of computer devices at one location, or may be executed on a plurality of computer devices distributed at a plurality of locations and connected by a communication network. The plurality of computer devices distributed at the plurality of locations and connected by the communication network can form a blockchain system.

A person of ordinary skill in the art may understand that all or some of the steps of the foregoing embodiments may be implemented by hardware, or may be implemented by a program instructing relevant hardware. The program may be stored in a computer-readable storage medium. The storage medium may be a read-only memory, a magnetic disk, an optical disc, or the like.

What is claimed is:

1. A road surface generation method, performed by a computer device, the method comprising:
obtaining a plurality of road links of an electronic map;
expanding the plurality of road links for obtaining a plurality of road surfaces having widths;
determining, when an overlap of road surfaces exists among the plurality of road surfaces, a first group of width adjustment ratios for adjusting the widths of the plurality of road surfaces;
adjusting a width adjustment ratio of at least one road surface among the plurality of road surfaces in the first group of width adjustment ratios for obtaining a second group of width adjustment ratios of the plurality of road surfaces, wherein an absolute value of a difference between width adjustment ratios in the second group of width adjustment ratios of any two road surfaces among the plurality of road surfaces is not greater than a ratio threshold; and
adjusting the widths of the plurality of road surfaces based on the second group of width adjustment ratios.

2. The method according to claim 1, wherein adjusting the width adjustment ratio of the at least one road surface among the plurality of road surfaces in the first group of width adjustment ratios for obtaining a second group of width adjustment ratios of the plurality of road surfaces comprises:
determining a plurality of imbalanced road surface pairs among the plurality of road surfaces according to the first group of width adjustment ratios of the plurality of road surfaces, wherein an absolute value of a difference between width adjustment ratios of two road surfaces of any imbalanced road surface pair among the plurality of imbalanced road surface pairs is greater than the ratio threshold;
clustering the plurality of imbalanced road surface pairs for obtaining at least one imbalanced road surface set; and
adjusting width adjustment ratios of road surfaces in the at least one imbalanced road surface set in the first group of width adjustment ratios for obtaining the second group of width adjustment ratios, wherein an absolute value of a difference between width adjustment ratios of any two road surfaces in any imbalanced road surface set among the at least one adjusted imbalanced road surface set is not greater than the ratio threshold.

3. The method according to claim 2, wherein determining a plurality of imbalanced road surface pairs among the plurality of road surfaces according to the first group of width adjustment ratios of the plurality of road surfaces comprises:
determining, when an absolute value of a difference between a width adjustment ratio of each road surface among the plurality of road surfaces and a width adjustment ratio of an adjacent road surface of the road surface is greater than the ratio threshold, the each road surface and the adjacent road surface as an imbalanced road surface pair.

4. The method according to claim 3, wherein the method further comprises:
traversing a plurality of adjacent road surfaces of the road surface;
using each adjacent road surface among the plurality of adjacent road surfaces as a currently traversed adjacent road surface;
comparing, when a serial number of the road surface is less than a serial number of the currently traversed adjacent road surface, the width adjustment ratio of the road surface and a width adjustment ratio of the currently traversed adjacent road surface; and
determining, when an absolute value of a difference between the width adjustment ratio of the road surface and the width adjustment ratio of the currently traversed adjacent road surface is greater than the ratio threshold, the road surface and the currently traversed adjacent road surface as one imbalanced road surface pair.

5. The method according to claim 3, wherein the method further comprises:
creating road space indexes based on the plurality of road links, the road space indexes comprising a minimum bounding rectangle of each road link among the plurality of road links; and
determining, when the minimum bounding rectangles of two road links have an overlapped region, road surfaces corresponding to the two road links as adjacent road surfaces.

6. The method according to claim 2, wherein clustering the plurality of imbalanced road surface pairs for obtaining at least one imbalanced road surface set comprises:
creating an imbalanced road surface group for each road surface among the plurality of imbalanced road surface pairs, the imbalanced road surface group being configured for storing a road surface having a width adjustment ratio imbalanced with each road surface;
adding, for each imbalanced road surface pair, each road surface in the imbalanced road surface pair to an imbalanced road surface group of the other road surface in the imbalanced road surface pair; and
clustering the imbalanced road surface group of each road surface among the plurality of imbalanced road surface pairs for obtaining the at least one imbalanced road surface set, wherein a width adjustment ratio of any road surface in an imbalanced road surface set of the at least one imbalanced road surface set is imbalanced with at least one road surface in the imbalanced road surface set.

7. The method according to claim 6, wherein clustering the imbalanced road surface group of each road surface among the plurality of imbalanced road surface pairs for obtaining the at least one imbalanced road surface set comprises:
creating a first set, the first set being configured for storing clustered road surfaces among the plurality of imbalanced road surface pairs;
traversing road surfaces in the plurality of imbalanced road surface pairs and using each road surface in the plurality of imbalanced road surface pairs as a currently traversed road surface;
creating an imbalanced road surface set when the first set does not comprise the currently traversed road surface; and
adding the currently traversed road surface and the road surfaces in an imbalanced road group of the currently traversed road surface to the first set and the imbalanced road surface set.

8. The method according to claim 7, wherein adding the currently traversed road surface and the road surfaces in an imbalanced road group of the currently traversed road surface to the first set and the imbalanced road surface set comprise:
adding the currently traversed road surface to the first set and a second set; and
performing target processing on each road surface in the second set, and, when the second set comprises no road surface, traversing a next road surface, wherein performing target processing on each road surface comprises:
moving the road surface from the second set to the imbalanced road surface set;
for any imbalanced road surface in the imbalanced road surface group of the road surface, adding the imbalanced road surface to the first set and the second set when the first set does not comprise the imbalanced road surface.

9. The method according to claim 2, wherein adjusting width adjustment ratios of road surfaces in the at least one imbalanced road surface set in the first group of width adjustment ratios for obtaining the second group of width adjustment ratios comprises:
determining a reference road surface in the imbalanced road surface set, the reference road surface being a road surface in a to-be-processed state and having a minimum width adjustment ratio in the imbalanced road surface set;
setting the reference road surface to be in a processed state;
obtaining an adjacent road surface in the to-be-processed state for the reference road surface in the imbalanced road surface set;
adjusting a width adjustment ratio of the adjacent road surface in the first group of width adjustment ratios, wherein an absolute value of a difference between the width adjustment ratio of the reference road surface and the adjusted width adjustment ratio of the adjacent road surface is not greater than the ratio threshold; and
continuing to determine a next reference road surface in the imbalanced road surface set, until all road surfaces in the imbalanced road surface set are in the processed state.

10. The method according to claim 9, wherein adjusting a width adjustment ratio of the adjacent road surface in the first group of width adjustment ratios, wherein an absolute value of a difference between the width adjustment ratio of the reference road surface and the adjusted width adjustment ratio of the adjacent road surface is not greater than the ratio threshold comprises:
determining a sum of the width adjustment ratio of the reference road surface and the ratio threshold as a candidate width adjustment ratio; and
determining a target width adjustment ratio as the adjusted width adjustment ratio of the adjacent road surface, the target width adjustment ratio being a minimum value of the width adjustment ratio of the adjacent road surface and the candidate width adjustment ratio.

11. The method according to claim 9, wherein determining a reference road surface in the imbalanced road surface set comprises:
generating an index value of each road surface in the imbalanced road surface set;
creating a minimum index tree according to a width adjustment ratio of a road surface in the imbalanced road surface set, the minimum index tree comprising an index value of the road surface in the to-be-processed state, a width adjustment ratio corresponding to an index value on a parent node in the minimum index tree being less than a width adjustment ratio corresponding to an index value on a child node; and
determining a road surface indicated by an index value on a root node of the minimum index tree as the reference road surface.

12. A road surface generation apparatus, comprising a memory for storing instructions and a processor for executing the instructions, wherein the processor is configured to:
obtain a plurality of road links of an electronic map□
expand the plurality of road links for obtaining a plurality of road surfaces having widths;
determine, when an overlap of road surfaces exists among the plurality of road surfaces, a first group of width adjustment ratios for adjusting the widths of the plurality of road surfaces;
adjust a width adjustment ratio of at least one road surface among the plurality of road surfaces in the first group of width adjustment ratios for obtaining a second group of width adjustment ratios of the plurality of road surfaces, wherein an absolute value of a difference between width adjustment ratios in the second group of width adjustment ratios of any two road surfaces among the plurality of road surfaces is not greater than a ratio threshold; and
adjust the widths of the plurality of road surfaces based on the second group of width adjustment ratios.

13. The road surface generation apparatus of claim 12, comprising a memory for storing instructions and a processor for executing the instructions, wherein the processor, being configured to adjust a width adjustment ratio of at least one road surface among the plurality of road surfaces in the first group of width adjustment ratios for obtaining a second group of width adjustment ratios of the plurality of road surfaces, is further configured to:
determine a plurality of imbalanced road surface pairs among the plurality of road surfaces according to the first group of width adjustment ratios of the plurality of road surfaces, wherein an absolute value of a difference between width adjustment ratios of two road surfaces of any imbalanced road surface pair among the plurality of imbalanced road surface pairs is greater than the ratio threshold;
cluster the plurality of imbalanced road surface pairs for obtaining at least one imbalanced road surface set; and
adjust width adjustment ratios of road surfaces in the at least one imbalanced road surface set in the first group of width adjustment ratios for obtaining the second group of width adjustment ratios, wherein an absolute value of a difference between width adjustment ratios of any two road surfaces in any imbalanced road surface set among the at least one adjusted imbalanced road surface set is not greater than the ratio threshold.

14. The road surface generation apparatus of claim 13, comprising a memory for storing instructions and a processor for executing the instructions, wherein the processor, being configured to determine a plurality of imbalanced road surface pairs among the plurality of road surfaces according to the first group of width adjustment ratios of the plurality of road surfaces, is further configured to:
determine, when an absolute value of a difference between a width adjustment ratio of each road surface among the plurality of road surfaces and a width adjustment ratio of an adjacent road surface of the road surface is greater than the ratio threshold, the each road surface and the adjacent road surface as an imbalanced road surface pair.

15. The road surface generation apparatus of claim 14, comprising a memory for storing instructions and a processor for executing the instructions, wherein the processor is further configured to:
traverse a plurality of adjacent road surfaces of the road surface;
use each adjacent road surface among the plurality of adjacent road surfaces as a currently traversed adjacent road surface;
compare, when a serial number of the road surface is less than a serial number of the currently traversed adjacent road surface, the width adjustment ratio of the road surface and a width adjustment ratio of the currently traversed adjacent road surface; and
determine, when an absolute value of a difference between the width adjustment ratio of the road surface and the width adjustment ratio of the currently traversed adjacent road surface is greater than the ratio threshold, the road surface and the currently traversed adjacent road surface as one imbalanced road surface pair.

16. The road surface generation apparatus of claim 14, comprising a memory for storing instructions and a processor for executing the instructions, wherein the processor is further configured to:
create road space indexes based on the plurality of road links, the road space indexes comprising a minimum bounding rectangle of each road link among the plurality of road links; and
determine, when the minimum bounding rectangles of two road links have an overlapped region, road surfaces corresponding to the two road links as adjacent road surfaces.

17. The road surface generation apparatus of claim 13, comprising a memory for storing instructions and a processor for executing the instructions, wherein the processor, being configured to cluster set for obtaining the at least one imbalanced road surface set, is further configured to:
create an imbalanced road surface group for each road surface among the plurality of imbalanced road surface pairs, the imbalanced road surface group being configured for storing a road surface having a width adjustment ratio imbalanced with each road surface;
add, for each imbalanced road surface pair, each road surface in the imbalanced road surface pair to an imbalanced road surface group of the other road surface in the imbalanced road surface pair; and
cluster the imbalanced road surface group of each road surface among the plurality of imbalanced road surface pairs for obtaining the at least one imbalanced road surface set, wherein a width adjustment ratio of any road surface in an imbalanced road surface set of the at least one imbalanced road surface set is imbalanced with at least one road surface in the imbalanced road surface set.

18. The road surface generation apparatus of claim 17, comprising a memory for storing instructions and a processor for executing the instructions, wherein the processor, being configured to cluster the imbalanced road surface group of each road surface among the plurality of imbalanced road surface pairs for obtaining the at least one imbalanced road surface set, is further configured to:
create a first set, the first set being configured for storing clustered road surfaces among the plurality of imbalanced road surface pairs;
traverse road surfaces in the plurality of imbalanced road surface pairs and using each road surface in the plurality of imbalanced road surface pairs as a currently traversed road surface;
create the imbalanced road surface set when the first set does not comprise the currently traversed road surface; and
add the currently traversed road surface and the road surfaces in an imbalanced road group of the currently traversed road surface to the first set and the imbalanced road surface set.

19. The road surface generation apparatus of claim 13, comprising a memory for storing instructions and a processor for executing the instructions, wherein the processor, being configured to adjust width adjustment ratios of road surfaces in the at least one imbalanced road surface set in the first group of width adjustment ratios for obtaining the second group of width adjustment ratios, is further configured to:
determine a reference road surface in an imbalanced road surface set, the reference road surface being a road surface in a to-be-processed state and having a minimum width adjustment ratio in the imbalanced road surface set;
set the reference road surface to be in a processed state;
obtain an adjacent road surface in the to-be-processed state for the reference road surface in the imbalanced road surface set;
adjust a width adjustment ratio of the adjacent road surface in the first group of width adjustment ratios, wherein an absolute value of a difference between the width adjustment ratio of the reference road surface and the adjusted width adjustment ratio of the adjacent road surface is not greater than the ratio threshold; and
continue to determine a next reference road surface in the imbalanced road surface set, until all road surfaces in the imbalanced road surface set are in the processed state.

20. A non-transitory computer readable medium storing a plurality of instructions, wherein the plurality of instructions, when executed by a processor, configure the processor to:
obtain a plurality of road links of an electronic map□
expand the plurality of road links for obtaining a plurality of road surfaces having widths;
determine, when an overlap of road surfaces exists among the plurality of road surfaces, a first group of width adjustment ratios for adjusting the widths of the plurality of road surfaces;
adjust a width adjustment ratio of at least one road surface among the plurality of road surfaces in the first group of width adjustment ratios for obtaining a second group of width adjustment ratios of the plurality of road surfaces, wherein an absolute value of a difference between width adjustment ratios in the second group of width adjustment ratios of any two road surfaces among the plurality of road surfaces is not greater than a ratio threshold; and
adjust the widths of the plurality of road surfaces based on the second group of width adjustment ratios.
